(19) United States
(12) Patent Application Publication
(10) Pub. No.: US 2007/0059409 A1
(43) Pub. Date: Mar. 15, 2007

(54) Elutable substance delivery devices

(76) Inventors: Steven J. Catani, Athens, GA (US); William J. Chapello, Atlantic Highlands, NJ (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/225,369

(22) Filed: Sep. 13, 2005

(51) Int. Cl. A23L 1/00

(52) U.S. Cl. 426/134

(57) ABSTRACT

Devices for delivering an elutable substance to a water-containing foodstuff, for example, a beverage, are provided. More particularly, devices for delivering an elutable substance to a foodstuff having an elongate body with at least one surface, wherein a composition including a elutable substance dissolved or dispersed in a carrier is affixed to at least a portion of the surface of the body are provided. Also provided are methods of producing such devices.

### FIELD OF THE INVENTION

The present invention relates to devices for delivering elutable substances to a water-containing foodstuff, for example, a beverage. More particularly, the present invention relates to a elutable substance delivery device having an elongate body with at least one surface, wherein a composition including a elutable substance dissolved or dispersed in a carrier is affixed to at least a portion of the surface of the elongated body. The present invention also relates to methods of producing such devices.

### BACKGROUND OF THE INVENTION

People often customize the taste, texture, aroma, and color of food and beverages by adding elutable substances thereto. In particular, consumers often add sweeteners to their foods and beverages and consumers differ considerably in the amount of sweetness that they prefer. For example, sweeteners are added to beverages, such as, coffee and tea; on cereals; on fruit; as toppings on baked goods; and in many other ways. Sweetening a food or beverage alters its flavor and usually increases its appeal. This behavior is found in all cultures, but is especially prevalent in western cultures.

The amount of sweetness incorporated into a foodstuff during commercial production may not be adequate to satisfy some consumers while other consumers may find that the same amount of sweetness to be excessive. Therefore, there exists a long-felt need for mechanisms that consumers can use to increase the sweetness of a product at the time of consumption that is consistent with their personal preference, without introducing an additional caloric burden.

Methods for dispensing elutable substances into a liquid are known. For example, adding sweetener to an unsweetened iced tea beverage will typically involve several steps—adding the sweetener to the unsweetened iced tea beverage followed by stirring to incorporate the sweetener to create a sweetened iced tea beverage. Such sweetener is typically in a powdered, liquid, or tablet form. Similar effort is undertaken when adding powdered or liquid beverage mix to a liquid, e.g., water, milk, alcohol, and the like.

The availability of high intensity sweeteners (HIS) provides novel technical routes to the delivery of sweeteners to individual servings of beverages. These new technical approaches are made possible by the minute quantities of these sweeteners needed to achieve adequate sweetening of individual servings. For example, sucralose is about 600 times as sweet as sucrose (table sugar or cane sugar). Therefore, one teaspoon of sugar (about 4 g) can be replaced by only about 6.7 mg of sucralose.

Sweetening individual servings of a beverage presents a challenge in many food service situations. Frequently, an individual packet of a sweetener is provided along with a serving of a beverage. The packet may contain sucrose, or alternatively may contain high intensity sweeteners such as sucralose, aspartame, or saccharin. The user must open the packet and empty the contents into the beverage, and then stir the beverage to obtain dissolution of the sweetener and its complete dispersion in the liquid mass. The residual packaging of the packet creates waste that may present disposal problems under many situations. Also, a device is needed to stir the liquid to which the sweetener has been added. This stirring device may be a reusable or disposable spoon. More frequently, especially in casual dining, convenience stores, or fast food situations a simpler stir stick is provided. This stick may be wooden, but more generally it is an extruded plastic object.

The multi-step process involved in satisfactorily adding an elutable substance to a liquid has been addressed by many methods. Most of these methods combine a stirring device with the elutable substance, e.g., sweetener, flavor, coffee, cocoa, tea, and the like.

One such approach is directed to placing a free flowing elutable substance inside a container having a receptacle for holding the substance.

U.S. Pat. No. 3,154,418, which is expressly incorporated herein by reference, discloses, among other things, a spoon having two cavities. One cavity is covered by a mesh and is used to contain a material, such as, tea, coffee, or cocoa for making a beverage. A second cavity was purported to be in a handle of the spoon. This second cavity is used to deliver beverage components, such as, sweetener. Delivery of material from the second chamber is achieved by squeezing the spoon handle or shaft of the stir stick, thereby breaking a seal and permitting the contents to flow into the beverage by gravity.

U.S. Pat. No. 3,824,322, which is expressly incorporated herein by reference, discloses a flavored tubular stirrer for alcoholic beverages. The disclosed stirrer was described as having stirring and handle portions, and flavoring means for aqueous alcoholic beverages that is held to a stirring portion of the stirrer with at least part of the flavoring communicable with an alcoholic beverage in which it is placed through or at an exterior surface of the stirring portion. The flavoring means were described as being a natural extract, a solid, or be capable of being converted to solid form by being deposited on or sorbed by a carrier. The carrier was described as being a sugar, sorbitol, manitol, corn syrup solids, milk solids, monoglycerides or diglycerides, and the like. In addition, the perforations were disclosed as being pushed inwardly so as to provide projections to assist in holding the flavoring means in place therein.

U.S. Pat. Nos. 4,860,929 and 4,986,451, which are expressly incorporated herein by reference, allegedly disclose a dispensing device for soluble granular material. The device includes a tube containing a solid granular material. The tube being closed at both ends and having perforations along a portion of its length and having a paddle formed at one end. In this design and in the dry state, the granular material must be sized so as not to escape through the perforations while the granular material is in a dry state.

U.S. Pat. No. 5,125,534, which is incorporated herein by reference, discloses a multiple compartment dispenser that is capable of simultaneously dispensing multiple dry flavoring ingredients into a fluid. The dispenser described contains a chamber having a spine with a plurality of vanes or blades projecting therefrom that extend into a lower housing to form multiple compartments. The lower housing was described as being a dissolvable film, such as, gelatin or methylcellulose, that is formed to fit over the bottom portion of the spine and the associated horizontally projecting vanes. Each of the multiple compartments was described as being individually filled with a flavoring ingredient prior to dispensing. Flavoring ingredients included sugar, coffee, hot chocolate, and bouillon.

U.S. Pat. No. 5,440,976, which is incorporated herein by reference, allegedly discloses a device for dispensing natural and artificial sweeteners into a beverage. The device includes a tube having perforations and at least one separator disk positioned therein, and a solid sleeve formed to receive the tube. The tube is in the sleeve such that the tube may be urged forward dispensing a measured amount of sweetener into the beverage. Control of sweetness intensity was allegedly described as being further enhanced by providing calibration markers on the surface of the tube.

U.S. Pat. No. 5,866,185, which is expressly incorporated herein by reference, discloses a device including a tube including a soluble or dispersible material and a soluble coating formed on the outer surface of the tubular portion. The soluble coating can be sugar or an artificial sweetener and is dissolved when the coating comes into contact with liquid. The tube is also disclosed as having perforations to control the rate that the soluble material is dispersed in the liquid. The soluble material was described as being a variety of substances that are soluble in liquid, including flavors, such as, cherry, orange, grape, and fruit punch.

Another approach is directed to attaching a solid mass to a handle and dissolving the solid mass in a liquid.

U.S. Pat. No. 3,869,555, which is incorporated herein by reference, discloses a soluble solid mass secured to a wooden stick. The solid mass was discloses as having a base mass and an optional flavoring mass. The base mass was described as being instant coffee crystals or particles, tea, cocoa, eggnog, and chocolate with binder material. The flavoring mass was described as being powdered milk and/or sugar that is held together by a binder material, which could be sugar or may be taste-free.

U.S. Pat. No. 4,849,231, which is expressly incorporated herein by reference, discloses a stirring rod having a stirring body that has a holder for holding a solid mass, e.g., sugar lump. More than one holder can be included in the body of the stirring rod. In addition to sugar lumps, sweetener tablets containing high intensity sweeteners, such as, aspartame or saccharin, powdered milk, coloring, and flavoring are disclosed. In another embodiment, there is disclosed a wooden stirring body that was immersed in a warm, liquid sugar or other substance, where a quantity of substance has remained adhered thereto, the quantity corresponding to a quantity of substance, for example sugar or sweetener, e.g., aspartame, geared to an amount of beverage. After cooling, the solid piece of the substance is held by a holder. The quantity of substance to be added to the beverage was disclosed as being regulated by inserting the stirring rod more or less deeply into the beverage that is to be stirred.

U.S. Pat. No. 6,399,126, which is incorporated herein by reference, discloses a flavored beverage stirrer that includes a carrier and a cartridge. The cartridge was disclosed as being formed from a flavored material, which dissolves and adds flavor to a beverage.

U.S. Published Patent Application No. 2001/0038871, which is incorporated herein by reference, discloses an embodiment wherein a predetermined quantity of a water soluble extract is sprayed onto the inner surface of a straw. The coated-interior of the straw will provide an agent of choice to be incorporated into a liquid.

The above approaches suffer from a number of drawbacks. In particular, due to the complexity of most of the above solutions, manufacturing costs and difficulties present obstacles to adoption. In addition, none of the solutions address the problem of increasing the dissolution rate of an elutable substance while maintaining the same compact size of the device.

### SUMMARY OF THE INVENTION

The present invention is directed to a device that satisfies these needs. This disclosure provides new individual serving sweetening compositions that avoid the cost of complicated manufacturing and the difficulties experienced in controlling the amount of an elutable substance delivered to a foodstuff.

One embodiment of the invention is a device for delivering a elutable substance to a foodstuff comprising, consisting of, and/or consisting essentially of an elongate body with at least one surface, wherein a composition comprising, consisting of, and/or consisting essentially of the elutable substance is dissolved or dispersed in a carrier and is affixed to at least a portion of the surface of the body.

Another embodiment of the present invention is a device for delivering a elutable substance comprising, consisting of, and/or consisting essentially of a semi-permeable or impermeable body that is a rectangular prism with a length of about 6 inches, a width of about one-quarter of an inch and a depth of about one-thirty-second of an inch, wherein a composition comprising, consisting of, and/or consisting essentially of maltodextrin and sucralose is disposed on a surface of the prism, wherein the amount of sucralose in the composition is sufficient to deliver about 3 sucrose equivalent teaspoons of sweetness to a foodstuff.

A further embodiment of the present invention is a method of producing a device for delivering an elutable substance. This method comprises, consists of, and/or consists essentially of (a) providing a device having a body with a first end and a second end, (b) coating at least a portion of the body with (1) a composition including a carrier or (2) a composition including a elutable substance dispersed in a carrier; and (c) allowing the composition to dry to a surface of the body of the device, wherein upon contacting a coated surface of the body with a foodstuff, the elutable substance is dispersed into the foodstuff.

A further embodiment of the invention is a method of producing a device for delivering a elutable substance comprising, consisting of, and/or consisting essentially of providing a body that is a rectangular prism with a length of about 6 inches, a width of about one-quarter of an inch, and a depth of about one-thirty-second of an inch made of wood, dissolving about 500 grams of maltodextin and about 500 grams of sucralose in sufficient water to solubilize them, coating a portion of the body with the solution (e.g., by submerging at least a portion of the body in the solution for about 5 seconds), and drying the body to form a coating adhered to the surface of the body, wherein the amount of sucralose affixed to the surface of the body is about 3 sucrose equivalent teaspoons of sweetness.

### BRIEF DESCRIPTION OF THE DRAWINGS

FIG. 1 shows an embodiment of the present invention.

FIG. 2 shows an embodiment of the present invention a cylindrical stirring rod.

FIG. 3 shows a front view (3A) and side view (3B) of an embodiment of the present invention.

FIG. 4A shows an embodiment of the present invention. FIG. 4B shows cross-sectional views 1₁-1₂ of the embodiment depicting FIG. 4A.

FIGS. 5A-C show various embodiments of the present invention.

FIGS. 6A-H show various embodiments of the present invention.

FIGS. 7A-C and E show various embodiments of the present invention. FIG. 7D depicts a cross-sectional view through plane 120 of the embodiment shown in FIG. 7A. FIG. 7F depicts a cross-sectioned view through plane 220 of the embodiment shown in FIG. 7E.

FIGS. 8A-C show various embodiments of the present invention.

FIG. 9 shows an embodiment of the present invention.

FIG. 10A shows an embodiment of the present invention.

FIG. 10B depicts a view through plane 350.

FIG. 11 shows an embodiment of the present invention.

FIG. 12 shows an embodiment of the present invention.

### DETAILED DESCRIPTION OF THE INVENTION

The present invention relates to subject disclosed in U.S. Application Serial No.______, entitled “ELUTABLE SUBSTANCE DELIVERY DEVICES,” which was filed on Sep. 13, 2005, and is hereby incorporated by reference as if recited in full herein.

One embodiment of the present is an elutable substance delivery device having an elongate body with at least one surface, wherein a composition including an elutable substance dissolved or dispersed in a carrier is affixed to at least a portion of the surface of the body.

As used herein, unless otherwise indicated, the term “elutable substance” means any substance that dissolves or can be suspended in a liquid, which comprises water with or without other solutes. Examples of useful elutable substances include high intensity sweeteners, nutritive sweeteners, sugar alcohols, flavors, drug substances, vitamins, minerals, texture enhancers, coloring agents, aromas, and combinations thereof. A preferred elutable substance according to the present invention is a high intensity sweetener.

As used herein, unless otherwise indicated, the term “high intensity sweetener” means a substance that provides a high sweetness per unit mass as compared to sucrose and provides little or no nutritive value. Many high intensity sweeteners are known to those skilled in the art and any can be used in the present invention. Examples of high intensity sweeteners for use in the present invention include aspartame, acesulfame, alitame, brazzein, cyclamic acid, dihydrochalcones, extract of Dioscorophyllum cumminsii, extract of the fruit of Pentadiplandra brazzeana, glycyrrhizin, hemandulcin, monellin, mogroside, neotame, neohesperidin, saccharin, sucralose, stevia, thaumatin, salts, derivatives, and combinations thereof. A preferred high intensity sweetener according to the present invention is sucralose.

The intensity of a sweetener may be assessed by determining the amount of the sweetener required to provide a sweetness comparable to a predetermined mass of a natural sugar, sucrose. In the present invention, this parameter is expressed in terms of “sucrose equivalent sweetness.” For example, if a sweetener is twice as intense as sucrose, 0.5 g of the sweetener equals a gram of sucrose equivalent sweetness.

As used herein, unless otherwise indicated, the term “nutritive sweetener” means a substance that provides sweetness and is also absorbable into the bloodstream and may be metabolized to provide energy for immediate use or for storage as fat. Nutritive sweeteners are typically extracted from plants that produce them in various quantities and for various purposes. For example, sucrose, a nutritive sweetener in widespread use, is produced from, e.g., sugar cane and sugar beet roots. Examples of nutritive sweeteners useful in the present invention include, e.g., corn syrup, glucose, fructose, tagatose, high fructose corn syrup, lactose, sucrose, trehalose, lactose, arabinose, trehalose, maltodextrin, soluble starch, inulin, and the like, alone or in combination.

As used herein, unless otherwise indicated, the term “sugar alcohol” means an alcohol derived from a sugar molecule. Sugar alcohols useful in the present invention include, for example, isomalt, erythritol, hydrogenated isomaltulose, hydrogenated starch hydrolyzates, lactitol, maltitol, mannitol, sorbitol, xylitol, and combinations thereof.

As used herein, unless otherwise indicated, the term “drug substance” means materials with pharmacological or nutritional benefits. Drug substances useful in the present invention include, for example, acetaminophen, ibuprofen, famotidine, chlorpheniramine, pseudoephedrine, dextromethorphan, diphenhydramine, brompheniramine, clemastine, phenylpropanolamine, terfenadine, astemizole, loratadine, loperamide, loperamide-N-oxide, ranitidine, cimetidine, tramadol, cisapride, acetylsalicylic acid, doxylamine succinate, pharmaceutically acceptable salts thereof and combinations thereof.

As used herein, unless otherwise indicated, the term “flavor” means any substance that may be employed to produce a desired flavor. Any flavor know to those skilled in the art may used in the present invention. The flavor used may be selected based on the type of foodstuff that will be contacted with the device for delivering a hydrophilic composition. Flavors useful for flavoring coffee include, for example, cream, hazelnut, vanilla, chocolate, cinnamon, and pecan. In contrast, flavors useful for flavoring tea include, for example, lemon, lime, raspberry, peach, and mango. Blends of flavors are also suitable for these applications. Useful flavors include, for example, the above-mentioned flavors and vanillin, butter, butterscotch, tea, orange, tangerine, walnut, caramel, strawberry, banana, grape, plum, cherry, blueberry, pineapple, elderberry, watermelon, bubblegum, cantaloupe, guava, kiwi, papaya, coconut, mint, spearmint, and combinations thereof.

As used herein, unless otherwise indicated, the term “texture enhancer” means any substance that may be employed to produce a desired texture. Texture enhancers useful in the present invention include, for example, guar gum, alginate and salts thereof, taro gum, gellan gum, xanthium gum, amalose, amalopectin, konjac, and combinations thereof.

As used herein, unless otherwise indicated, the term “coloring agent” means any substance that may be employed to produce a desired color. Coloring agents useful in the present invention include, for example, FD&C Blue No. 1 (Brilliant Blue), FD&C Blue No. 2 (Indigotine), FD&C Green No. 3 (Fast Green), FD&C Red No. 3 (Erythrosine), FD&C Red No. 40 (Allura Red), FD&C Yellow No. 5 (Tartrazine), FD&C Yellow No. 6 (Sunset Yellow), annatto extract, anthocyanis, aronia/redfruit, beet juice & powder, beta-carotene, beta-apo-8-carotenal, black currant, burnt sugar, canthaxanthin, caramel, carbo medicinalis, carmine, carmine/beta-carotene, carmine blue, carminic acid, carrot & carrot oils, chlorophyll, chlorophyllin, cochineal extract, copper-chlorophyll, copper-chlorophyllin, curcumin, curcumin/cu-chlorophyllin, elderberry, grape & grape skin, extracts, hibiscus, lutein, mixed carotenoids, paprika, paprika extract, paprika oleoresin, riboflavin, saffron, spinach, stinging nettle, titanium dioxide, turmeric, and combinations thereof.

As used herein, unless otherwise indicated, the term “aroma” means any volatile substance that may be employed to produce a desired scent. Aromas useful in the present invention include, for example, anethole (liquorice, anise seed, ouzo, fennel), anisole (anise seed), benzaldehyde (marzipan, almond), benzyl alcohol (marzipan, almond), camphor (cinnamomum camphora), cinnamaldehyde (cinnamon), citral (citronella oil, lemon oil), d-limonene (orange) ethyl butanoate (pineapple), eugenol (clove oil), furaneol (strawberry), furfural (caramel), linalool (coriander, rose wood), menthol (peppermint), methyl butanoate (apple, pineapple), methyl salicylate (oil of wintergreen), neral (orange flowers), nerolin (orange flowers), pentyl butanoate (pear, apricot), pentyl pentanoate (apple, pineapple), sotolon (maple syrup, curry, fennugreek), strawberry ketone (strawberry), substituted pyrazines, e.g., 2-ethoxy-3-isopropylpyrazine; 2-methoxy-3-sec-butylpyrazine; and 2-methoxy-3-methylpyrazine (toasted seeds of fenugreek, cumin, and coriander), thujone (juniper, common sage, Nootka cypress, and wormwood), thymol (camphor-like), trimethylamine (fish), vanillin (vanilla), and combinations thereof.

As used herein, unless otherwise indicated, the term “body” means any structure capable of being coated with a carrier when the carrier is dissolved in a solvent. The solvent may be any food-grade solvent or combination thereof, for example, water, ethanol, and ethyl acetate. The body may be made of any material that is inert in relation to the solvent, i.e., neither dissolves in nor reacts with water. Examples of materials useful in the construction of the bodies of the present invention include, for example, wood, metal, plastic, and mineral materials. Preferably, the body is made from a semi-permeable or impermeable material, e.g., a plastic. The body, alternatively may be coated with a material that renders its surface semi-permeable or impermeable.

A preferred material for the construction of the body is plastic. Bodies composed of plastic are well-known and have a low cost. Metals and mineral materials, such as, glass, may also be used. Plastic is generally non-porous, and its use avoids absorption into its surface, while in turn, allowing greater control of the timing of, e.g., sweetener delivery. For example, in the case of a sweetener that permeates a stirrer surface, delivery of the sweetener to the foodstuff will be delayed. Consequently, a user will have less control over the amount of sweetness delivered to the foodstuff by, as in the present invention, controlling the depth of the stirrer in the foodstuff. Wood may also be used in the present invention and has the advantage of being biodegradable, and therefore, is environmentally friendly. Hardwoods have low permeability and are preferred. While wood is inherently environmentally friendly, plastics, metals, and mineral materials are long-lasting and may therefore be reused many times. Accordingly, plastics, metals, or mineral materials may also be employed in the present invention in an environmentally-friendly manner.

The body may have a substantially smooth surface, which is uninterrupted by any perforations, crimps, channels, cavities, or the like. This smooth surface of the body is advantageous because it allows for simple and cost-effective manufacture of the body. Accordingly, it is also preferred that the composition is disposed on a surface of the device and is freely accessible to a liquid. And, therefore, any substance disposed on the surface of the body will be released from the body instantaneously or nearly instantaneously upon contact with a liquid. For example, if the elutable substance is sucralose, then sweetness will be provided to the liquid immediately upon contact with the device.

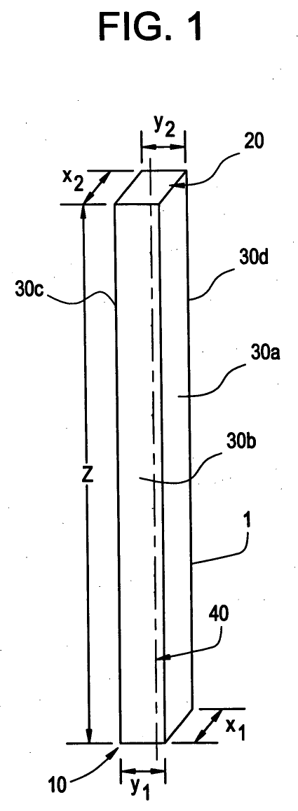

Turning now to FIG. 1, one embodiment of the present invention is a body (1) having the shape of a square prism. The body has a first end (10), a second end (20), a plurality of sides (30a-d), and a central axis (40) running through the center of the body (1). Elutable substance (11) is affixed to body (1). The body has a length (z), width (x), and depth (y), which dimensions are defined by the following equations:
x₁=a₁·y₁
x₂=a₂·y₂
y₂=c·y₁
z=b·(y₁+y₂)
wherein x₁ and y₁ are the width and depth, respectively, of the first end of the body (10), x₂ and y₂ are the width and depth, respectively, of the second end of the body (20), a₁, and a₂ each equal from about 0.05 to about 20, b is greater than about 10, and c can be up to about 100. In a preferred embodiment, a₂, is from about 0.25 to about 4, a₂ is from about 0.25 to about 4, b is about 20, and c is about 1.

As used herein, all numerical ranges provided are intended to expressly include at least all numbers that fall between the endpoints of ranges.

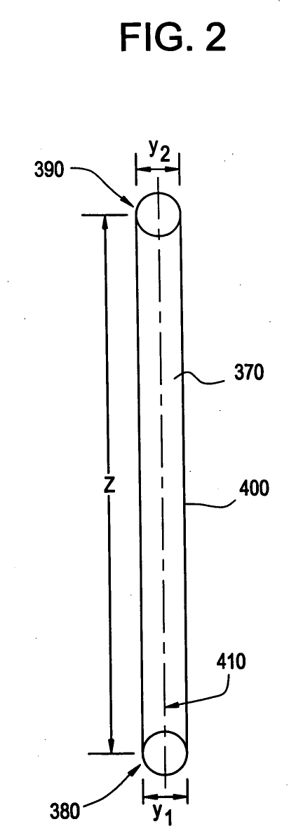

FIG. 2 shows a conventional stirrer having a cylindrical, rod-shaped body (370). The body has a first end (380), a second end (390), an outer surface (400), and a central axis (410) running through the center thereof. Elutable substance (325) is deposited on body (370). In this figure, y₁, and y₂ represent the diameter at the first and second ends (380 and 390), respectively.

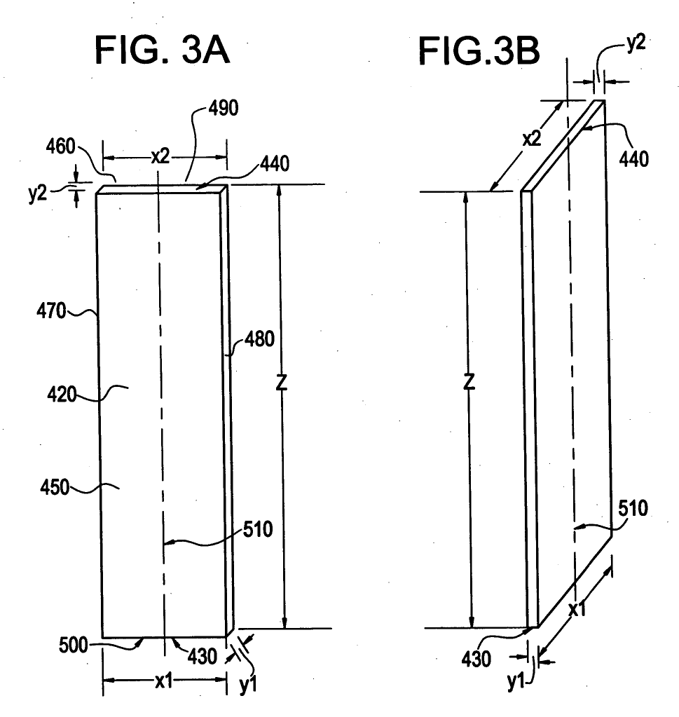

Turning now to FIG. 3A, a rectangular prism is depicted having a body (420) with a first end (430) and a second end (440). Elutable substance (425) is deposited on body (420). The rectangular prism has a front (450), a back (460), sides (470 and 480), and top and bottom sides (490 and 500, respectively). A central axis (510) runs through the center of the rectangular prism. FIG. 3B shows a side view of the rectangular prism of FIG. 3B. In FIGS. 3A and B, z represents the length of the rectangular prism, x₁ and y₁ represent the width and depth, respectively, of the rectangular prism at first end (430) and x₂ and Y₂ represent the width and depth, respectively, of the rectangular prism at second end (440).

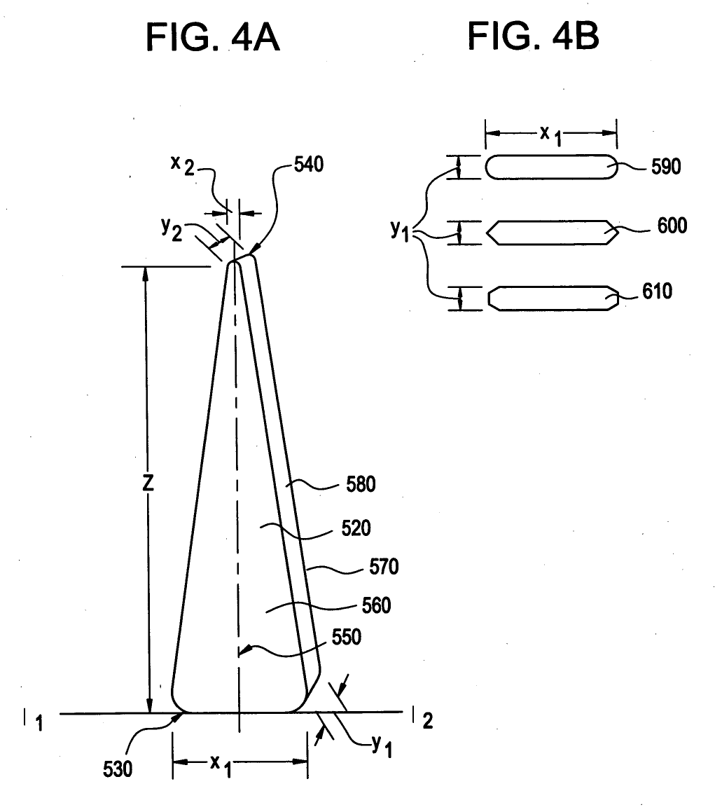

Now turning to FIG. 4A, another embodiment of the present invention has a modified tongue depressor shape as shown with body (520) a wider first end (530) a narrower second end (540), and a central axis (550) running down the center of the body. Elutable substance (525) is deposited on body (520). The body has a front (560), a back (570), and a central portion (580) between the front and back. In this embodiment, z is the length from the first end (530) to the second end (540), x₁ and y₁, are the width and depth, respectively, at the first end (530) and x₂ and y₂ are the width and depth, respectively, at the second end (540). FIG. 4B is a cross section through plane perpendicular to the central axis (550) at the first end of the body (1₁-1₂). As depicted, the cross-sectional form may take a plurality of shapes (e.g., 590, 600, and 610).

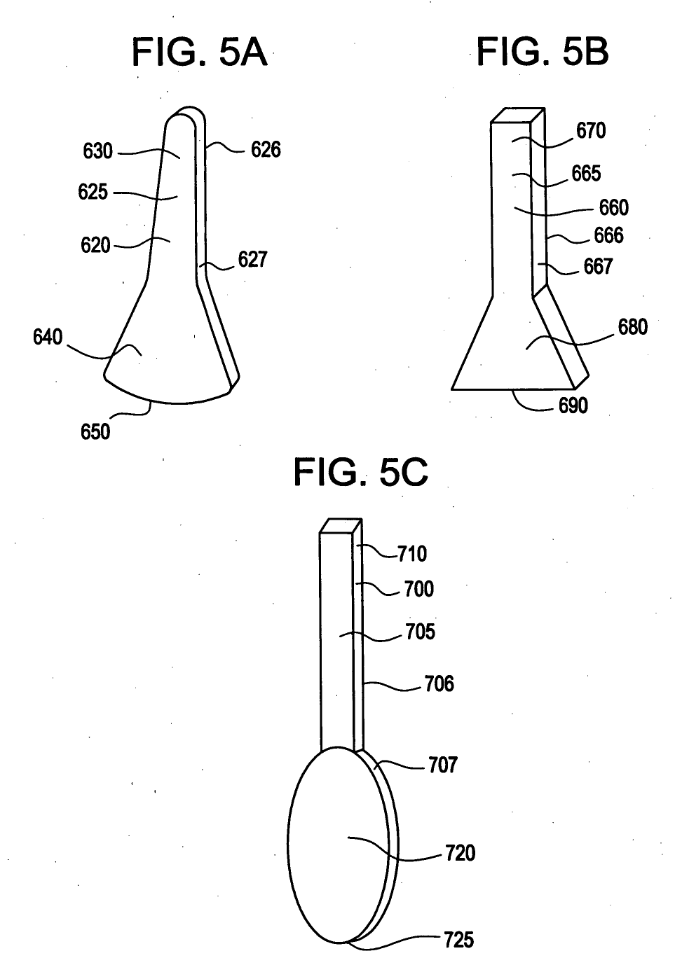

Turning now to FIG. 5, the body shape may take the form of various “spoons” (FIGS. 5A, 5B, and 5C). Elutable substance (55′, 55″, 55′″) is deposited on spoon (620, 660, and 700). With reference to FIG. 5A, for example, the spoon (620) may have a relatively narrow handle portion (630), which is integrally connected to an end portion (640) that is wider than the handle portion and terminates with a curved end (650). With reference to FIG. 5B, the spoon (660) may have a relatively narrow handle portion (670), which is integrally connected to an end portion (680) that is wider than the handle portion and terminates with a straight end (690). With reference to FIG. 5C, the spoon (700) may have a relatively narrow handle portion (710), which is integrally connected to an end portion (720) that is wider than the handle portion and terminates in a point (725). Each spoon has a front (625, 665, and 705), a back (626, 666, and 706), and a side portion (627, 667, and 707).

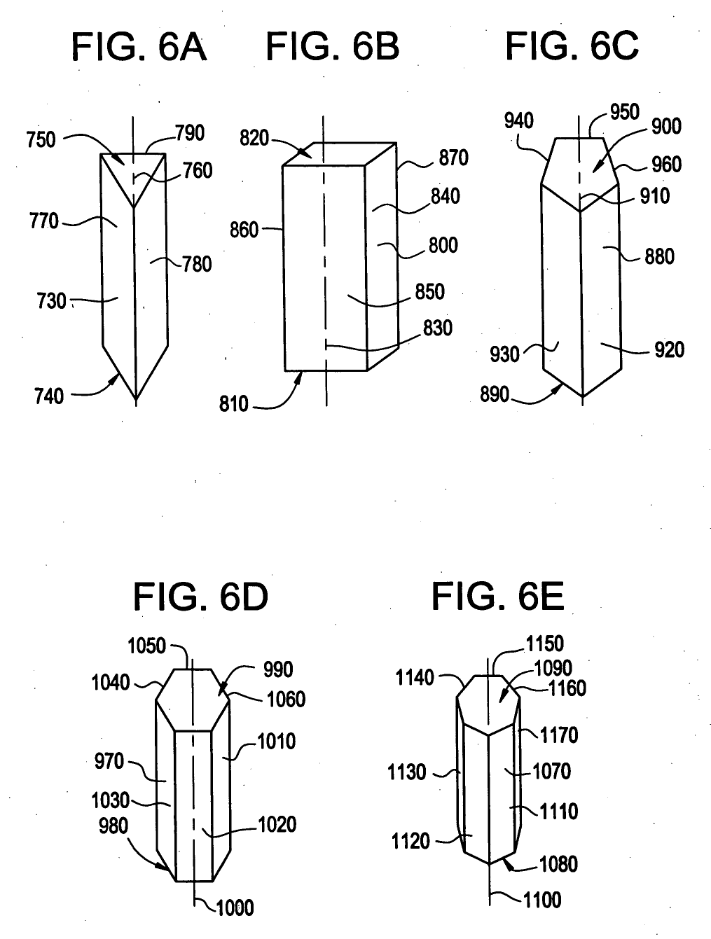

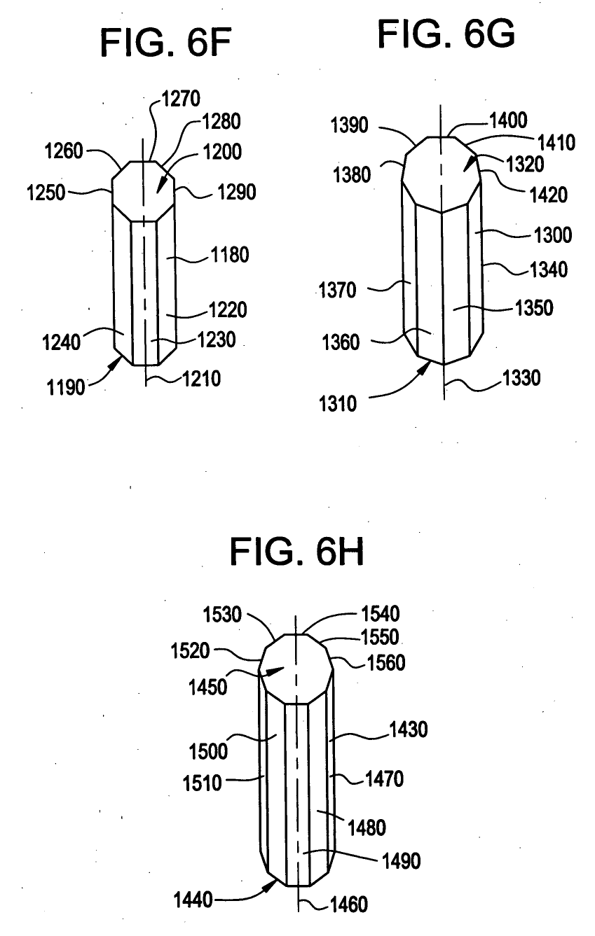

Turning now to FIG. 6, depicted are various exemplary prism shapes that may be used as the body of the device. In particular, FIG. 6 depicts a triangular prism (FIG. 6A), a rectangular prism (FIG. 6B), a pentagonal prism (FIG. 6C), a hexagonal prism (FIG. 6D), heptagonal prism (FIG. 6E), an octagonal prism (FIG. 6F), a nonagonal prism (FIG. 6G), and a decagonal prism (FIG. 6H). In each instance, the first and second ends, central axis, and respective sides are shown as summarized in the Table below:

| | | First | Second | Central | | Elutable |
|---|---|---|---|---|---|---|
| Figure | Body | End | End | Axis | Sides | Substance |
| 6A | 730 | 740 | 750 | 760 | 770, 780, | 66^{A} |
| | | | | | 790 | |
| 6B | 800 | 810 | 820 | 830 | 840, 850, | 66^{B} |
| | | | | | 860, 870 | |
| 6C | 880 | 890 | 900 | 910 | 920, 930, | 66^{C} |
| | | | | | 940, 950, | |
| | | | | | 960 | |
| 6D | 970 | 980 | 990 | 1000 | 1010, 1020, | 66^{D} |
| | | | | | 1030, 1040, | |
| | | | | | 1050, 1060 | |
| 6E | 1070 | 1080 | 1090 | 1100 | 1110, 1120, | 66^{E} |
| | | | | | 1130, 1140, | |
| | | | | | 1150, 1160, | |
| | | | | | 1170 | |
| 6F | 1180 | 1190 | 1200 | 1210 | 1220. 1230, | 66^{F} |
| | | | | | 1240, 1250, | |
| | | | | | 1260, 1270, | |
| | | | | | 1280, 1290 | |
| 6G | 1300 | 1310 | 1320 | 1330 | 1340, 1350, | 66^{G} |
| | | | | | 1360, 1370, | |
| | | | | | 1380, 1390, | |
| | | | | | 1400, 1410, | |
| | | | | | 1420 | |
| 6H | 1430 | 1440 | 1450 | 1460 | 1470, 1480, | 66^{H} |
| | | | | | 1490, 1500, | |
| | | | | | 1510, 1520, | |
| | | | | | 1530, 1540, | |
| | | | | | 1550, 1560 | |

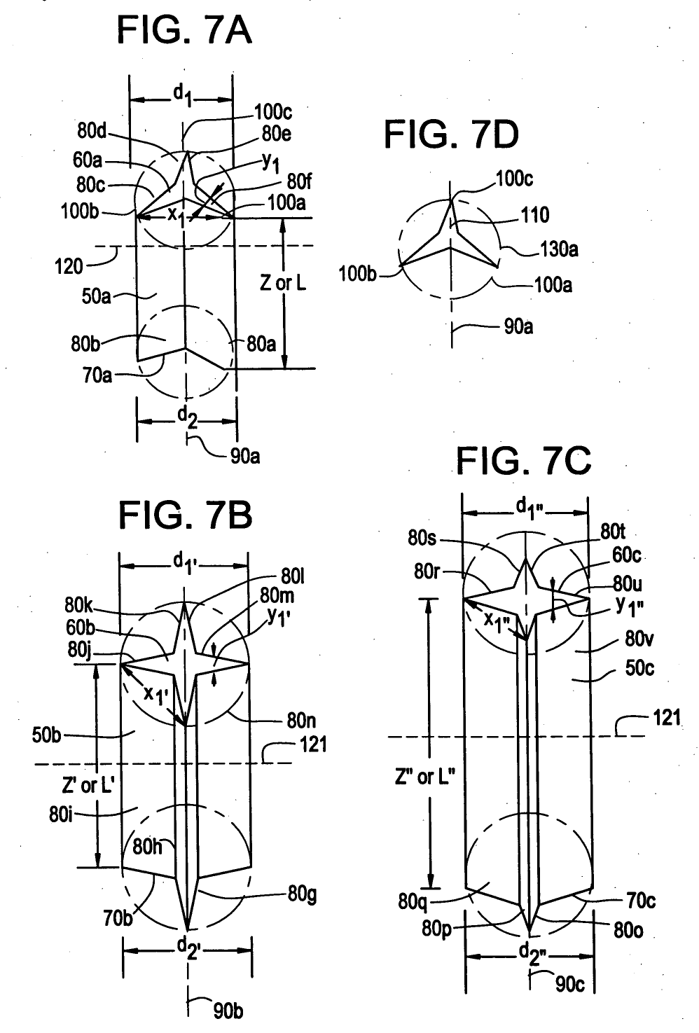

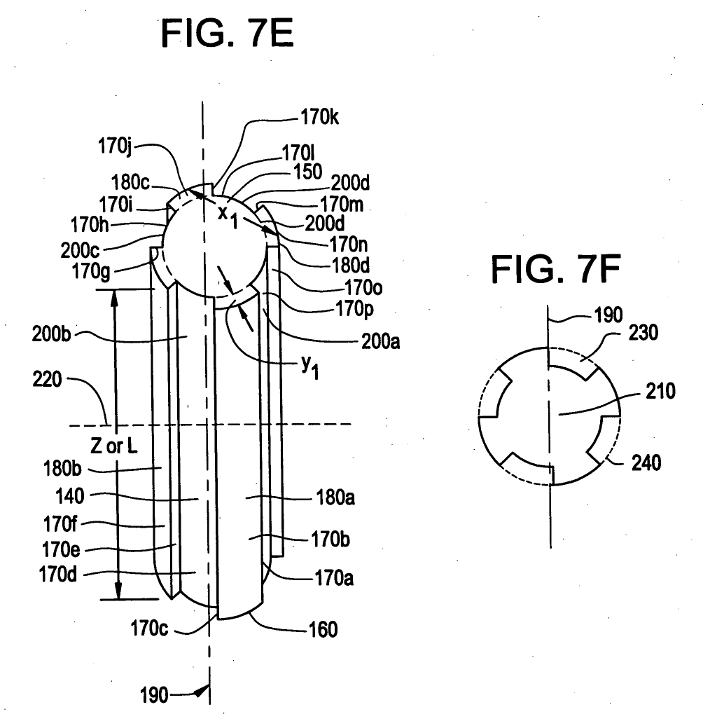

Turning now to FIGS. 7A-C, the shape of the body of the present invention is not limited to a rectangular shape as shown in FIG. 1. For example, the body may be a polyhedron, such as for example an eight-sided shape (FIG. 7A) or a ten-sided shape (FIG. 7B or 7C). In these embodiments, the body (50a, b, c) has a first end (60a-c) and a second end (70a-c) and a plurality of sides (80a-v) that separate the first and second ends by a length (L or z; L′or z′; L″ or z″) and radiate out from a central axis (90a-c) running longitudinally through the center of the body. Elutable substance (77^{A}, 77^{B} and 77^{C}) is deposited on body 50 a; b, and c). With reference to FIG. 7A, adjacent sides (e.g., 80a/f; 80b/c; 80d/e) meet in points (100 a, b, c) and form a star (110) when viewed as a cross-section (FIG. 7D) through a plane (120) perpendicular to the central axis (90a). The length of the body is greater than a diameter of a circle (130a) whose center is bisected by the central axis (90a) and whose perimeter lies along the points of the star (100a, b, c). Although formation of the star by taking a cross-section through rectangular prism 3A is described, the same holds true for any like rectangular prism, such as those shown in FIGS. 3B and C (e.g., when the cross-section is taken through plane 121 that is perpendicular to central axes 90b and c).

Turning now to FIG. 7E, the body (140) the has a first end (150) and a second end (160) and a plurality of sides (170a-p) that separate the first and second ends by a length (L or z), wherein a plurality of teeth (180a-d) extend out from a central axis (190) running longitudinally through the center of the body. Elutable substance (77^{D}) is deposited on body (140). Each tooth (180a-d) comprises at least three adjacent sides (e.g., 170a-c) of the body that are configured to form at least first and second lateral faces (e.g., 170a and c) rising from a trough (200a-d) and a forward face (e.g., 170b) interconnecting the lateral faces (170a and c). The teeth form a gear-like form (210) when viewed as a cross-section (FIG. 7F) through a plane (220) perpendicular to the central axis (190). The length of the body is greater than a diameter of a circle (230) whose center is bisected by the central axis (190) and whose perimeter (240) lies along the forward face (170b, f, j, n) of each tooth.

In a preferred embodiment and with reference to FIGS. 7A-C, the body has a length (L, L′, or L″) and a diameter (d₁, d_{1′}, d_{1″}; d₂, d_{2′}, d_{2″}) are defined by the following equations:
0.01<d₁/d₂<100
L/((d₁+d₂)/2)>10
wherein d₁ (or d_{1′} or d_{1″}) is a diameter of a cross-section at the first end (60a, b, or c) of the body, and d₂ (or d_{2′} or d_{2″}) is a diameter of a cross section at the second end of the body (70a, b, c). More preferably, d₁/d₂ is about 1 and L/((d₁+d₂)/2) is about 20.

In an additional embodiment, the dimensions of the body are defined by the following equations:
x₁=a₁·y₁
x₂=a₂·y₂
y₂=c·y₁
z=b·(y₁+y₂)
wherein z (or z′or z″) is the distance between the first and second ends of the body, x₁ (or x_{1′} or x_{1″}) and x₂ (or x_{2′} or x_{2″}) (x₂, x_{2′}, and x_{2″} not shown) are the distances in a body having cross-sectional stars between two adjacent points of the cross-sectional stars formed by cross-sections taken at the first and second ends, respectively. With reference to FIG. 7E, x₁ and x₂ (not shown) are the distances in a body (220) having cross-sectional gears between the apexes of two adjacent teeth (e.g., 180c and 180d) at a cross-section taken at the first and second ends (150 and 160), respectively. With reference to FIGS. 7A-C, y₁(or y_{1′} or y_{1″}) and y₂(or y_{2′} or y_{2″}) (not shown), respectively, represent the distance between two points on adjacent sides that form an apex of the star in cross-sectional form with respect to the first and second ends, wherein the two points are equidistant between the apex of the star and the central axis of the body. With reference to FIG. 7E, y₁ and y₂ (not shown), respectively, represent the distance from the bottom of a trough to the apex of a tooth of a gear in a cross-section taken at the first and second ends of the body, respectively. a₁, and a₂ each equal from about 0.05 to about 20, b is greater than about 10, and c is up to about 100. The blades of the cross-sectional stars or the teeth of the cross-section gear may be of equal length or may be of different lengths.

In an additional embodiment, the body has a cross-sectional star with from 3 to 25 points. Preferably, the body has a cross-sectional star with from 3 to 6 points, more preferably 3 points. In another embodiment, the body has a cross-section gear with 2 to 25 teeth. Preferably, the body has a cross-section gear with 3 to 15 teeth, more preferably 3 teeth.

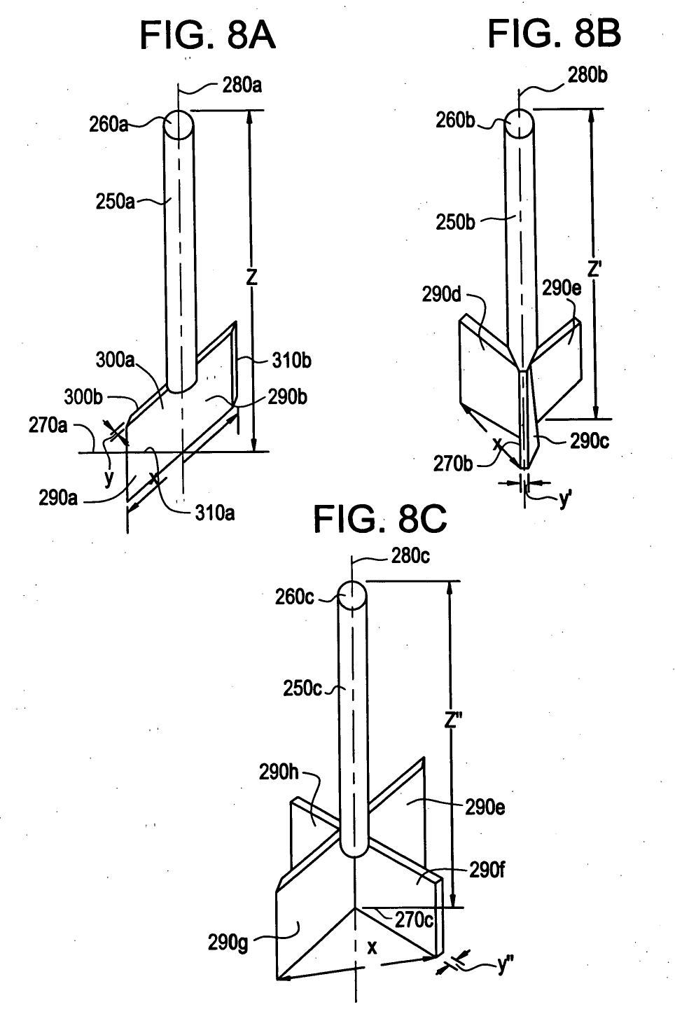

Turning now to FIG. 8, a further embodiment of the present invention has a body (250a-c) with first (260a-c) and second (270a-c) ends, a central axis (280a-c) running longitudinally through the center of the body, and two or more blades (290a-i) that are integrally connected to one of the ends of the body. Elutable substance (88′, 88″, 88′″) is deposited on body (250 a-c). Each blade has a first and second surface (e.g., 300a and 300b in FIG. 8A) and an apex (e.g., 310a and 310b in FIG. 8A). In a preferred embodiment, the dimensions of the body are defined by the following equations:
x=a·y
z=b·y
wherein x is the distance between apexes (e.g., 310a and 310b) of two adjacent blades (e.g., 290a and 290b), y is the distance between the first and second surfaces (e.g., 300a and 300b) of the blades at a point equidistant from the central axis (280a) and the apex (e.g., 310a) of the blade (e.g., 290a), z is the distance from the first end of the body (e.g., 260a) to the second end (e.g., 270a), a is from about 1 to about 100, and b is greater than about 10. More preferably, a is about 10 and b is about 20. With respect to FIGS. 8B and C, x′, x″, y′, y″, z′, and z″, are defined in the same manner.

In an embodiment of the present invention, the body has from 2 to 8 blades, preferably 3 blades, integrally connected.

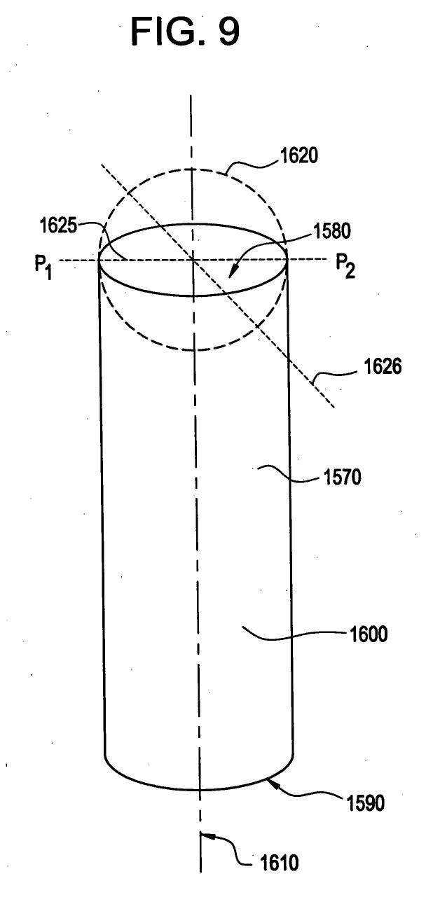

Turning now to FIG. 9, the body (1570) is depicted in the shape of an elliptical cylinder. The body has a first end (1580), a second end (1590), an outer surface (1600), and a central axis (1610) running through the center of the cylinder. Elutable substance (99) is deposited on body (1570). The dotted line circumscribes a circle (1620) whose perimeter lies along points p₁ and p₂, which are at opposite ends of the major axis (1625) of an ellipse formed by taking a cross-section through a plane (1626) that is perpendicular to the central axis (1610) at the first end (1580).

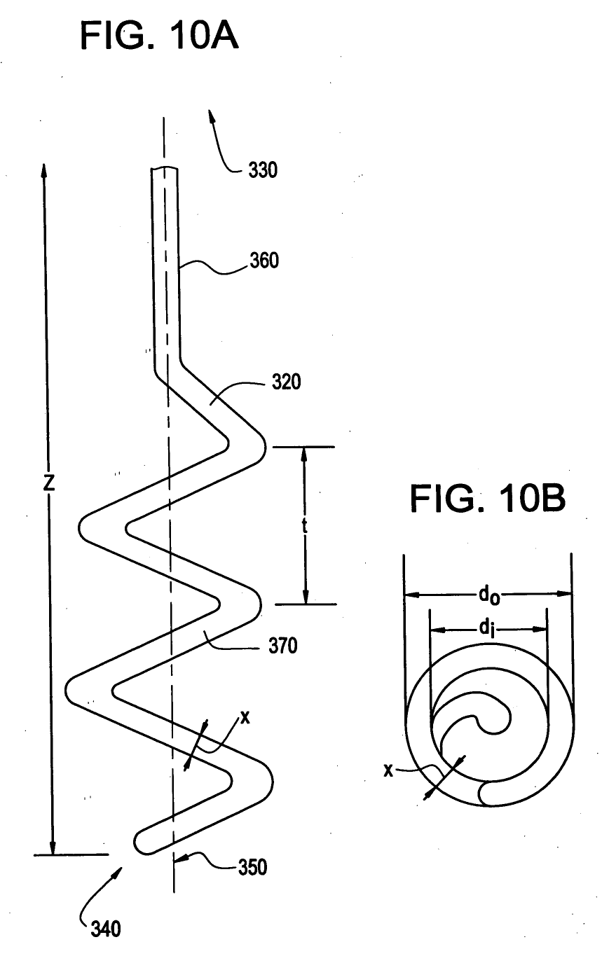

Now turning to FIG. 10, the body (320) has first (330) and second (340) ends and a central axis (350) running longitudinally through the center of the body (320). Elutable substance (1010) is deposited on body (320). A first portion (360) of the body is rod-shaped and a second portion (370) is a three-dimensional spiral. The body (320) has a length (z) measured from the first end (330) to the second end (340), which is from about 4 to about 8 inches, and a width (x) of from about one-eighth of an inch to about one-half of an inch. With reference to FIG. 10B, which shows a bottom view of the body of FIG. 10A, the outer diameter of the spiral (dₒ) may be from about one-quarter of an inch to about 1 inch. The inner diameter of the spiral (dᵢ) may be from 0 to about seven-eights of an inch. The vertical distance over which the spiral portion of the body completes one full turn (360°) (t) may be from about one-quarter to about one inch. In a preferred embodiment of the spiral shaped body, the length (z) is about 6 inches, the width (x) is about one-quarter of an inch, the outer diameter (dₒ) of the spiral is about one-half of an inch, the inner diameter (dᵢ) of the spiral is about one-quarter of an inch, and t equals about one-half inch.

The body of the present invention may be solid, hollow, or partially hollow. Hollow or partially hollow bodies increase the surface area available for adhering the carrier and the hydrophilic agent. The bodies, for example, may be solid, hollow throughout their entire length, or hollow for some portion of the length, e.g., one-half of the length.

As used herein, unless otherwise indicated, the term “carrier” means any water-soluble, food-grade polymer. The carrier may have the following desirable characteristics:

contains few or no calories;

is highly soluble in water;

when dissolved in water the carrier forms a solution with high viscosity;

does not impregnate the material of the body; and

does not react with the material of the body.

Examples of useful carriers include, for example, starch, guar gum, alginate, glucan, pullan, gellan, and combinations thereof. A preferred carrier is maltodextrin. When dried on the surface of the body, the carrier forms a coating. Preferably, the coating is a polymer matrix in which the elutable substance is incorporated or onto which the elutable substance is dispersed as a powder.

As used herein, unless otherwise indicated, the term “food-grade” material is one that conforms to the standards for foods deemed safe for human consumption set forth in the Codex Alimentarius produced by the World Health Organization (1999).

In an embodiment of the present invention, the elutable substance is a high intensity sweetener and the amount of the high intensity sweetener incorporated into or on the surface of the coating on the body is sufficient to produce from about ½ to about 6, preferably about 1 to about 4, more preferably about 1 sucrose equivalent teaspoons of sweetness per unit length of the body.

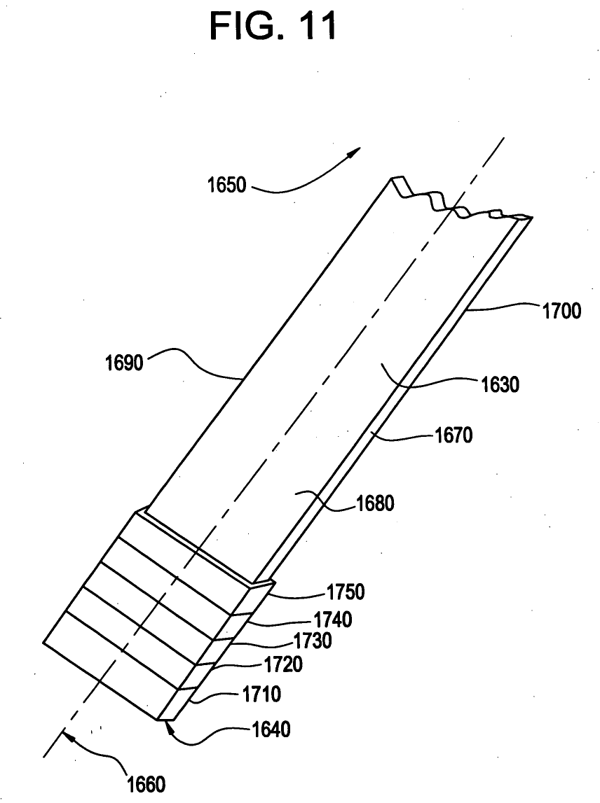

In another embodiment, the composition is distributed about the surface of the body in one or more bands, the composition in each band containing a predefined amount of the elutable substance. Turning now to FIG. 11, a body (1630) in the shape of a rectangular prism is shown having a first end (1640), a second end (1650), a central axis (1660), and sides (1670, 1680, 1690, and 1700). A composition according to the present invention is applied in a plurality of bands (1710-1750) about each side of the body. As shown, band 1710 is directly adjacent to band 1720, which is adjacent to band 1730, which is adjacent to band 1740, which is adjacent to band 1750.

Preferably, the amount of the elutable substance in each band increases, from band 1710 positioned at the first end (1640) of the body, progressively to subsequent bands (1720, 1730, 1740, and 1750) positioned above the first band. Preferably, the composition of the first band contains an amount of an high intensity sweetener sufficient to provide about one sucrose equivalent teaspoon of sweetness to a foodstuff and the composition of each subsequent band contains an amount of the high intensity sweetener sufficient to provide to a foodstuff twice the sweetness of the composition in the band adjacent to, and below, it. Preferably, band 1710 contains an amount of high intensity sweetener sufficient to provide one-half a sucrose equivalent teaspoon of sweetness to a foodstuff and the composition of each subsequent band above it contains an amount of high intensity sweetener that provides twice the sweetness of the band adjacent to, and below, it.

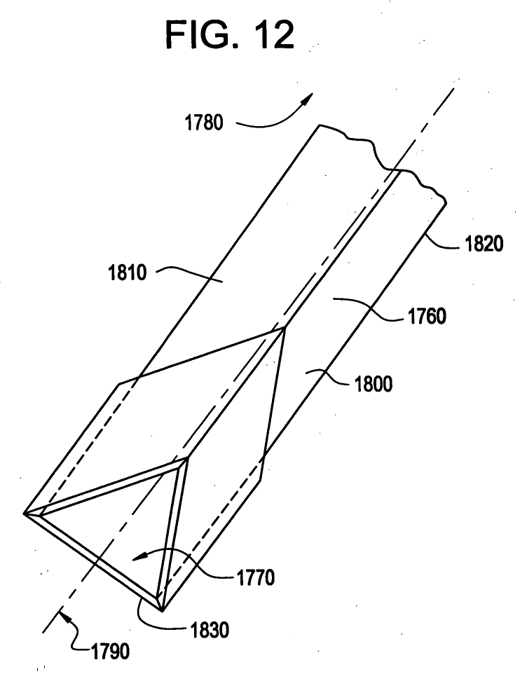

Turning now to FIG. 12, a body (1760) in the shape of a triangular prism is shown having a first end (1770), a second end (1780), a central axis (1790), and sides (1800, 1810, and 1820). A composition according to the present invention is applied in a band (1830) about each side of the body. Alternatively, to at least a portion of each side (1800, 1810, and 1820) of the body, a different composition according to the present invention may be applied (not shown).

The devices for delivering an elutable substance may also have one or more additional elutable substances adhered to their surface. Preferred additional elutable substances include, for example, different high intensity sweeteners, flavors, texture enhancers, coloring agents, and aromas. More preferred are flavors, for example, hazelnut and cream flavors and blends and combinations thereof.

In a further embodiment of the present invention, the composition is disposed about the surface of the body in a plurality of adjacent bands (e.g., bands 1710-1730 of FIG. 11), the composition of each band containing a different elutable substance. Preferably, the device has a first band defined by a composition wherein the elutable substance is sucralose, a second band adjacent to the first band, defined by a composition wherein the elutable substance is hazelnut flavor, and a third band, adjacent to the second band, defined by a composition wherein the elutable substance is a cream flavor, wherein the first band is oriented on the body below the second band, which is oriented below the third band.

Alternatively, the body is a triangular prism and a first composition having sucralose is disposed on a first side of the prism, a second composition comprising having a hazelnut flavor is disposed on a second side of the prism, and a third composition having a cream flavor is disposed on a third side of the prism.

In the present invention, the composition may be visually detectable. For example, the composition may further contain a coloring agent that is visually detectable on the body. Alternatively, the body may be colored and the presence of the composition, with or without a coloring agent, may be visually detectable. For example, the body may be white and a red coloring agent maybe added to the composition, which coats the body. The presence of the coating may then be easily detected by noting the presence of a pink or red color on the surface of the body.

The devices for delivering an elutable substance of the present invention may be packaged in a many ways. For example, the devices for delivering an elutable substance may be placed into boxes, envelopes, pouches, or other suitable packages. A small number of devices for delivering a elutable substance, for example, about 2 to about 50, may be placed in a suitable package for the convenience of a single user. The incorporation of these into a pouch or an envelope may be particularly convenient for the user. A larger number of devices for delivering an elutable substance, for example, from about 50 to about 5000, may be packaged into a single container. This approach may be especially suitable for food service applications.

The devices for delivering an elutable substance of the present invention may also be individually packaged into a suitable protective container. This container may be a sealed pouch or a sleeve made from plastic film or paper. The container may also be a tube formed of plastic or cardboard. The container may also be formed from a metal foil or a combination of the materials disclosed above. Individually packaged containers may be especially useful in situations where hygiene may be compromised, such as camping trips, outdoor activities, or crowded conditions.

The devices of the present invention may be used in connection with an elutable substance into a dispenser that simplifies their use, e.g., the dispenser facilitates the release of a single device for delivering an elutable substance. One example is a dispenser containing a sliding or hinged opening, wherein the diameter of the opening permits only one device to be released at a time. Another example is a dispenser with a depressible or sliding button or tab, wherein each actuation of the sliding button or tab results in the ejection of a single device for delivering an elutable substance. These dispensers have a benefit of requiring only one hand for their use, while permitting the user to simultaneously hold a food container in the other hand.

An additional embodiment of the present invention is a method of producing a device for delivering an elutable substance. With reference to FIG. 12, this method includes (a) providing a device having a body (1760) with a first end (1770) and a second end (1780), (b) coating at least a portion of the body (1830) with (1) a composition including a carrier or (2) a composition including an elutable substance dispersed in a carrier, and (c) allowing the composition to dry to a surface of the body of the device, wherein upon contacting a coated surface of the body with a foodstuff, the elutable substance is released into the foodstuff.

The composition may be formed by dissolving the carrier, and optionally the elutable substance in water. The coating step includes any way known to those of skill in the art to coat the surface of the body with the composition. Useful methods of coating the surface of the body include, for example, dipping or submerging the body in the composition and pouring, spraying, or brushing the composition onto the surface of the body. A preferred method of coating the body is to dip a portion of the body in the composition. If an elutable substance is included in the composition, the elutable substance will be incorporated into a polymer matrix coating on the surface of the body.

The carrier may be dissolved in any food-grade solvent, preferably water, in any amount sufficient to produce a solution with a viscosity of about 0.1 to about 100,000 centipoises measured at 21° C. Preferably, the solution has a viscosity of about 1 to about 10,000 centipoises measured at 21° C. More preferably, the solution has a viscosity of about 50 to about 5,000 centipoises measured at 21° C. Useful solutions, include for example, saturated solutions of the food-grade, water-soluble polymer, and optionally, an elutable substance at room temperature. A preferred solution is 20 grams of maltodextrin and 20 grams of sucralose in 100 milliliters of de-ionized water.

Optionally, prior to the drying step, the composition (i.e., (b)(1) or (b)(2)), which is disposed on a surface of the body, may be contacted with an elutable substance to form a dispersible layer of the elutable substance uniformly over the coated surface of the body. In this embodiment, the coated body may be dipped or dragged through an elutable substance or an elutable substance may be dusted or poured onto the coated body.

If an elutable substance is incorporated into the composition and another elutable substance is also contacted with the coated body, then two elutable substances may be adhered to the surface of the body. Likewise, if the same elutable substance is both incorporated into the composition and also contacted with the coated body, it is possible to significantly increase the loading of that single elutable substance because it will be both incorporated into and layered onto the surface of the polymer matrix coating on the body. The present invention also includes building multiple layers (e.g., from about 2 to about 10 layers) of elutable substances over the first coating layer.

In this method, the body shapes, elutable substances, amounts, and elutable substance dispersion patterns that may be employed in this method of delivering an elutable substance to a water-containing foodstuff are described above.

In this method, the body has a length (z) equal to the distance between the first and second ends (e.g., 1640 and 1650 of FIG. 11), a width (x) (e.g., side 1630 of FIG. 11), and a depth (y) (e.g., side 1670 of FIG. 11), wherein (z) is greater than (x) and (y).

In this embodiment, the elutable substance in the composition is sucralose and the sucralose is present in the composition in an amount sufficient to provide to a foodstuff from about ½ to about 6, more preferably from about 1 to about 4, even more preferably about 1, sucrose equivalent teaspoons of sweetness per unit length of the body.

In this method, two or more elutable substances may be dispersed on the surface of the body. The body may have a shape selected from a triangular prism, a rectangular prism, a pentagonal prism, a hexagonal prism, heptagonal prism, an octagonal prism, a nonagonal prism, and a decagonal prism. The coating step and the optional contacting step may carried out separately for two or more of the sides of the prism. Thus, each side of the prism may have one or more different elutable substances disposed on it. In this manner, it is possible to produce a device for delivering an elutable substance that has many different elutable substances adhered to it. If desired, after each successive coating step the body may be dried before adding the next composition. For example, a triangular prism may have sucralose, a hazelnut flavor, and a cream flavor adhered to the surface of the delivery device.

In this method, the coating, and optionally, the contacting and drying steps may be carried out for two or more elutable substances and in a manner such that the device has two or more bands of different elutable substance or bands of different amounts of an elutable substance disposed axially along the length of the body.

The bands may be oriented adjacent to each other beginning from the first end and proceeding upward toward the second end (see, e.g., FIG. 11) and the composition of each band may comprise a higher amount of the elutable substance compared to the band immediately below it. Preferably, the composition of the band closest to the first end includes an amount of sucralose that provides to a foodstuff one sucrose equivalent teaspoon of sweetness and the composition of each band above it includes an amount of sucralose that provides twice the sweetness of the band immediately below it. Also preferably, the composition of the band closest to the first end includes an amount of sucralose that provides to a foodstuff one-half a sucrose equivalent teaspoon of sweetness and the composition of each band above it includes an amount of sucralose that provides twice the sweetness of the band immediately below it.

Thus, devices of the present invention provide a simple method of delivering an elutable substance to a water-containing foodstuff by contacting the device with the foodstuff. The device for delivering an elutable substance may be contacted with the foodstuff in any known manner. Useful contacting methods include, for example, stirring, dunking, dipping, submerging, spinning, and twirling. Preferably, the foodstuff is stirred with the device for delivering an elutable substance.

As used herein, unless otherwise indicated, the term “water-containing foodstuff” means any edible substance containing sufficient water to release the elutable substance from the body upon contact. Useful water-containing foodstuffs include, for example, beverages, gels, puddings, sauces, gravies, syrups, and a glazes. A preferred foodstuff for the present invention is a beverage.

The elutable substances may be dispersed in a carrier polymer matrix coating and/or on the surface of the polymer matrix coating. Moreover, the polymer may be readily soluble in water. Therefore, the delivery of the elutable substance adhered to the surface of the body occurs instantaneously or nearly instantaneously upon contact with the foodstuff. Accordingly, which elutable substance is delivered and the amount of elutable substance delivered to the water-containing foodstuff may be dependent on the dispersion pattern of the elutable substance adhered to the surface of the delivery device and what parts of the device for delivering an elutable substance are brought into contact with the water-containing foodstuff.

For example, when the body is coated with a homogenous or near homogenous coating, when two or more elutable substances are adhered to different sides of a prism-shaped body, or when a non-linear amount of elutable substance in relation to the length of the body, is adhered to the surface of the body, the amount of the elutable substance delivered is governed only by the depth to which the body is submerged in the water-containing foodstuff. In contrast, when two or more elutable substances are adhered to the surface of the body in a banded pattern which elutable substances are delivered is dependent upon which bands are submerged in the water-containing foodstuff.

The following examples are provided to further illustrate the compositions and methods of the present invention. These examples are illustrative only and are not intended to limit the scope of the invention in any way.

### EXAMPLES

### Example 1

A device for delivering sucralose (Tate & Lyle PLC) is produced with a constant amount of sucralose per unit length of the device. A solid polyethylene cylinder having a length of 6 inches and a diameter of one-eighth of an inch is employed as the delivery device. 20 grams of starch and 10 grams of neat sucralose are dissolved in 100 milliliters of de-ionized water at a temperature of 25° C. The body is then submerged to a depth of 10 centimeters in the solution. The coated delivery device is then removed and placed on a metal rack suspended over a heat source and dried for 2 hours. The temperature at the rack is 30° C.

The device for delivering sucralose is then submerged in hot coffee thereby delivering 1 sucrose equivalent teaspoon of sweetness to the coffee for each centimeter of the device submerged.

### Example 2

A device for delivering sucralose is produced with a constant amount of sucralose per unit length of the device. A solid polyethylene cylinder having a length of 6 inches and a diameter of one-eighth of an inch is employed as the delivery device. 20 grams of starch are dissolved in 100 milliliters of de-ionized water at a temperature of 25° C. The body is then submerged to a depth of 10 centimeters in the solution. The coated delivery device is then dragged through or dusted with crystalline sucralose to cover the solution-coated portion. Around 60 mg of sucralose are adhered to the surface. The delivery device is then removed and placed on a metal rack suspended over a heat source and dried for 2 hours. The temperature at the rack is 30° C.

The device for delivering sucralose is then submerged in hot coffee thereby delivering 1 sucrose equivalent teaspoon of sweetness to the coffee for each centimeter of the device submerged.

### Example 3

A device for delivering sucralose is produced with increasing amounts of sucralose per unit length from the bottom toward the top of the device. A solid polyethylene cylinder having a length of 6 inches and a diameter of one-eighth of an inch is employed as the delivery device. Solutions are made as shown in Table 1.

TABLE 1
Starch and sucralose solutions.

| | Starch | Sucralose | De-Ionized Water |
|---|---|---|---|
| Solution | (g) | (g) | (ml) |
| a | 20 | 10 | 100 |
| b | 20 | 30 | 100 |
| c | 20 | 40 | 100 |
| d | 20 | 50 | 100 |
| e | 20 | 60 | 100 |

The solutions are made at and maintained at a temperature of 25° C. The body is then submerged to a depth of 5 centimeters in solution e. The coated body is then removed and placed on a metal rack suspended over a heat source and dried for 2 hours. The body is then submerged in de-ionized water to a depth of 4 centimeters to remove the coating. The body is then submerged to a depth of 4 centimeters in solution d. The coated body is then removed and placed on a metal rack suspended over a heat source and dried for 2 hours. The body is then submerged in de-ionized water to a depth of 3 centimeters to remove the coating. The body is then submerged to a depth of 3 centimeters in solution c. The coated body is then removed and placed on a metal rack suspended over a heat source and dried for 2 hours. The body is then submerged in de-ionized water to a depth of 2 centimeters to remove the coating. The body is then submerged to a depth of 2 centimeters in solution b. The coated body is then removed and placed on a metal rack suspended over a heat source and dried for 2 hours. The body is then submerged in de-ionized water to a depth of 1 centimeter to remove the coating. The body is then submerged to a depth of 1 centimeter in solution a. The coated body is then removed and placed on a metal rack suspended over a heat source and dried for 2 hours. The temperature at the drying rack is 30° C. for each drying.

The device for delivering sucralose is then submerged in hot coffee thereby delivering sweetness to the coffee as shown in Table 2.

TABLE 2
Sweetness delivery.

| | Sucrose Equivalent |
|---|---|
| Bands Submerged | Teaspoons of Sweetness |
| a | 1 |
| a & b | 3 |
| a, b, & c | 7 |
| a, b, c, & d | 15 |
| a, b, c, d, & e | 31 |

### Example 4

A device for delivering sucralose, hazelnut flavor, and cream flavor is produced. A solid polyethylene cylinder having a length of 6 inches and a diameter of one-eighth of an inch is employed as the delivery device. Solutions are made as shown in Table 3.

TABLE 3
Starch and sucralose or flavor solutions.

| | Starch | Elutable | Amount | De-Ionized Water |
|---|---|---|---|---|
| Solution | (g) | substance | (g) | (ml) |
| a | 20 | Sucralose | 10 | 100 |
| b | 20 | Hazelnut Flavor | 10 | 100 |
| c | 20 | Cream Flavor | 10 | 100 |

The solutions are made at and maintained at a temperature of 25° C. The body is then submerged to a depth of 3 centimeters in solution c. The coated body is then removed and placed on a metal rack suspended over a heat source and dried for 10 minutes. The body is then submerged in de-ionized water to a depth of 2 centimeters to remove the coating. The body is then submerged to a depth of 2 centimeters in solution b. The coated body is then removed and placed on a metal rack suspended over a heat source and dried for 10 minutes. The body is then submerged in de-ionized water to a depth of 1 centimeter to remove the coating. The body is then submerged to a depth of 1 centimeter in solution a. The coated body is then removed and placed on a metal rack suspended over a heat source and dried for 10 minutes. The temperature at the drying rack is 73° C. for each drying.

The device for delivering sucralose is then submerged in hot coffee thereby delivering sweetness to the coffee as shown in Table 4.

TABLE 4
Flavor delivery.

| Bands Submerged | Flavor(s) Delivered |
|---|---|
| A | Sucralose |
| a & b | Sucralose and Hazelnut Flavor |
| a, b, & c | Sucralose, Hazelnut Flavor, |
| | and Cream Flavor |

### Example 5

A device for delivering sucralose, hazelnut flavor, and cream flavor is produced. A solid polyethylene triangular having a length of 6 inches and three sides of equal width of one-eighth of an inch is employed as the delivery device. The same solutions used in Example 4 are used (Table 3.)

The solutions are made at and maintained at a temperature of 25° C. The first side of the body is then brushed with solution a on the bottom 10 centimeters of the length. The coated body is then removed and placed on a metal rack suspended over a heat source and dried for 2 hours. The second side of the body is then brushed with solution b on the bottom 10 centimeters of the length. The coated body is then removed and placed on a metal rack suspended over a heat source and dried for 2 hours. The third side of the body is then brushed with solution c on the bottom 10 centimeters of the length. The coated body is then removed and placed on a metal rack suspended over a heat source and dried for 2 hours

The device for delivering sucralose is then submerged in hot coffee thereby delivering sweetness, hazelnut flavor, and cream flavor to the coffee in increasing intensity as the depth of submersion is increased.

### Example 6

A device for delivering sucralose, hazelnut flavor, and cream flavor is produced. A solid polyethylene cylinder having a length of 6 inches and a diameter of one-eighth of an inch is employed as the delivery device. 20 grams of starch are dissolved in 100 milliliters of de-ionized water at a temperature of 25° C. The body is then submerged to a depth of 3 centimeters in the solution. The coated delivery device is then dragged through or dusted with a dry form of a cream flavor to cover the solution-coated portion. The body is then removed and placed on a metal rack suspended over a heat source and dried for 2 hours. The body is then submerged in de-ionized water to a depth of 2 centimeters to remove the coating. The body is then submerged to a depth of 2 centimeters in the solution. The coated delivery device is then dragged through or dusted with a dry form of a hazelnut flavor to cover the bottom 2 centimeters. The coated body is then removed and placed on a metal rack suspended over a heat source and dried for 2 hours. The body is then submerged in de-ionized water to a depth of 1 centimeter to remove the coating. The body is then submerged to a depth of 1 centimeter in the solution. The coated delivery device is then dragged through or dusted with crystalline sucralose to cover the bottom 1 centimeter. The coated body is then removed and placed on a metal rack suspended over a heat source and dried for 2 hours. The temperature at the drying rack is 30° C. for each drying.

The device for delivering sucralose is then submerged in hot coffee thereby delivering sweetness to the coffee as shown in Table 5.

TABLE 5
Flavor delivery.

| Bands Submerged | Flavor(s) Delivered |
|---|---|
| A | Sucralose |
| a & b | Sucralose and Hazelnut Flavor |
| a, b, & c | Sucralose, Hazelnut Flavor, |
| | and Cream Flavor |

In this experiment, a device for delivering controlled quantities of sucralose is produced. A solid polyethylene cylinder having a length of 6 inches (approximately 15 centimeter) and a diameter of one-eighth of an inch is used. 20 grams of guar gum are dissolved in 100 milliliters of de-ionized water at a temperature of 25° C. The bottom 9 centimeter of the body is then submerged in the solution. Three portions of the coated body and then dusted, each with a total amount of sucralose as shown in Table 6:

TABLE 6
Banded sucralose distribution.

| | | Dusting 1: | Dusting 2: | Dusting 3: |
|---|---|---|---|---|
| Distance from | Guar Gum | 8 mg | 32 mg | 18 mg |
| Bottom (cm) | Solution | Sucralose | Sucralose | Sucralose |
| 1 | Coated | Dusted | — | — |
| 2 | Coated | Dusted | — | — |
| 3 | Coated | Dusted | Dusted | — |
| 4 | Coated | Dusted | Dusted | — |
| 5 | Coated | — | Dusted | — |
| 6 | Coated | — | Dusted | — |
| 7 | Coated | — | Dusted | — |
| 8 | Coated | — | Dusted | Dusted |
| 9 | Coated | — | Dusted | Dusted |
| 10 | Coated | — | Dusted | Dusted |
| 11 | Uncoated | — | — | — |
| 12 | Uncoated | — | — | — |
| 13 | Uncoated | — | — | — |
| 14 | Uncoated | — | — | — |
| 15 | Uncoated | — | — | — |

After dusting, the device is then placed on a metal rack suspended over a heat source and dried for 2 hours at 30° C.

The device is then submerged, with stirring, in 8 ounces of hot coffee to the distance (from the bottom) shown in Table 7 and the amount of sucralose delivered to the coffee measured. The results are shown in Table 7.

TABLE 7
Sweetness delivery.

| | | | | Teaspoons of |
|---|---|---|---|---|
| Depth Dipped | Sucralose Delivered (mg) | | | Sucrose Equiv- |
| and Stirred; | From | From | From | alent Sweetness |
| From Bottom | Dusting | Dusting | Dusting | Delivered to |
| (cm) | 1 | 2 | 3 | Coffee |
| 1 | 2 | — | — | 0.3 |
| 2 | 4 | — | — | 0.6 |
| 3 | 6 | 4 | — | 1.4 |
| 4 | 8 | 8 | — | 2.2 |
| 5 | 8 | 12 | — | 2.8 |
| 6 | 8 | 16 | — | 3.3 |
| 7 | 8 | 20 | — | 3.9 |
| 8 | 8 | 24 | 6 | 5.2 |
| 9 | 8 | 28 | 12 | 6.6 |
| 10 | 8 | 32 | 18 | 8.0 |
| 11 | 8 | 32 | 18 | 8.0 |
| 12 | 8 | 32 | 18 | 8.0 |
| 13 | 8 | 32 | 18 | 8.0 |
| 14 | 8 | 32 | 18 | 8.0 |
| 15 | 8 | 32 | 18 | 8.0 |

As shown, using this embodiment, the delivery of custom amounts of sweetness to a beverage, e.g. coffee, is easily controlled based on the length of the cylinder submerged in the beverage.

The scope of the present invention is not limited by the description, examples and suggested uses herein and modifications can be made without departing from the spirit of the invention. Thus, it is intended that the present invention cover modifications and variations of this invention provided that they come within the scope of the appended claims and their equivalents.

What is claimed is:

1. A device for delivering an elutable substance to a foodstuff comprising an elongate body having at least one surface, wherein a composition comprising the elutable substance dissolved or dispersed in a carrier is affixed to at least a portion of the surface of the body.

2. A device according to claim 1, wherein the elutable substance is selected from the group consisting of a high intensity sweetener, a nutritive sweetener, a sugar alcohol, a flavor, a drug substance, a vitamin, a mineral, a texture enhancer, a coloring agent, an aroma, and combinations thereof.

3. A device according to claim 2, wherein the elutable substance is a high intensity sweetener.

4. A device according to claim 3, wherein the high intensity sweetener is selected from the group consisting of aspartame, acesulfame, alitame, brazzein, cyclamic acid, dihydrochalcones, extract of Dioscorophyllum cumminsii, extract of the fruit of Pentadiplandra brazzeana, glycyrrhizin, hemandulcin, monellin, mogroside, neotame, neohesperidin, saccharin, sucralose, stevia, thaumatin, salts, derivatives, and combinations thereof.

5. A device according to claim 4, wherein the high intensity sweetener is sucralose.

6. A device according to claim 1, wherein the composition forms a coating on a surface of the body.

7. A device according to claim 6, wherein the coating comprises, as the carrier, a polymer matrix in which the elutable substance is incorporated or onto which the elutable substance is dispersed as a powder.

8. A device according to claim 7, wherein the polymer matrix is a food-grade, water-soluble polymer.

9. A device according to claim 8, wherein the polymer is selected from the group consisting of starch, guar gum, maltodextrin, alginate, glucan, pullan, gellan, and combinations thereof.

10. A device according to claim 9, wherein the polymer is maltodextrin.

11. A device according to claim 1, wherein the body comprises first and second ends, such that the body has a length (z) equal to the distance between the first and second ends, a width (x), a depth (y), a central axis running longitudinally through the center of the body, and a plurality of surfaces.

12. A device according to claim 11, wherein the body has a shape selected from the group consisting of a cylinder, a triangular prism, a rectangular prism, a pentagonal prism, a hexagonal prism, an heptagonal prism, an octagonal prism, a nonagonal prism, a decagonal prism, a straw, an elliptical cylinder, a spoon, a multi-sided elongate member having a cross-section perpendicular to the central axis that is a multi-sided star, a multi-sided elongate member having a cross-section perpendicular to the central axis that is gear-shaped, a spiral, and a paddle.

13. A device according to claim 12, wherein the body has a shape selected from the group consisting of a rectangular prism, a cylinder, and a straw.

14. A device according to claim 13, wherein the body is in the shape of a rectangular prism with a length of about 6 inches, a width of about one-quarter of an inch, and a depth of about one-thirty-second of an inch.

15. A device according to claim 1, wherein the body is made of an inert material.

16. A device according to claim 15, wherein the inert material is selected from the group consisting of wood, metal, plastic, and combinations thereof.

17. A device according to claim 16, wherein the body is made of plastic.

18. A device according to claim 7, wherein the body further comprises first and second ends, such that the body has a length (z) equal to the distance between the first and second ends, a width (x), a depth (y), and a plurality of surfaces; and the composition, wherein the elutable substance is a high intensity sweetener, is dispersed on one or more surfaces of the body in sufficient quantity to provide to a foodstuff from about ½ to about 6 sucrose equivalent teaspoons of sweetness per unit length of the body.

19. A device according to claim 18, wherein the amount of the high intensity sweetener in the composition is sufficient to provide to a foodstuff from about 1 to about 4 sucrose equivalent teaspoons of sweetness per unit length of the body.

20. A device according to claim 19, wherein the amount of the high intensity sweetener in the composition is sufficient to provide to a foodstuff about 1 sucrose equivalent teaspoon of sweetness per unit length of the body.

21. A device according to claim 20, wherein the high intensity sweetener is sucralose.

22. A device according to claim 11, wherein the composition is distributed about the surface of the body in one or more bands, the composition in each band containing a predefined amount of the elutable substance.

23. A device according to claim 22, wherein the amount of the elutable substance in each band increases, from a first band positioned at the first end of the body, progressively to subsequent bands positioned above the first band.

24. A device according to claim 23, wherein the elutable substance is a high intensity sweetener and the composition of the first band contains an amount of the high intensity sweetener sufficient to provide one sucrose equivalent teaspoon of sweetness to a foodstuff and the composition of each subsequent band contains an amount of the high intensity sweetener sufficient to provide to a foodstuff twice the sweetness of the composition in the band adjacent to, and below, it.

25. A device according to claim 24, wherein the high intensity sweetener is sucralose.

26. A device according to claim 23, wherein the composition of the first band contains an amount of high intensity sweetener sufficient to provide one-half a sucrose equivalent teaspoon of sweetness to a foodstuff and the composition of each subsequent band above it contains an amount of high intensity sweetener that provides twice the sweetness of the band adjacent to, and below, it.

27. A device according to claim 26, wherein the high intensity sweetener is sucralose.

28. A device according to claim 3, wherein the composition further comprises an additional elutable substance selected from the group consisting of a different high intensity sweetener, a flavor, a texture enhancer, a coloring agent, an aroma and combinations thereof.

29. A device according to claim 28, wherein the additional elutable substance is selected from the group consisting of a hazelnut flavor, a cream flavor, and combinations thereof.

30. A device according to claim 11, wherein the composition is disposed about the surface of the body in a plurality of adjacent bands, the composition of each band containing a different elutable substance.

31. A device according to claim 30 comprising a first band defined by a composition wherein the elutable substance is sucralose, a second band adjacent to the first band, defined by a composition wherein the elutable substance is hazelnut flavor, and a third band, adjacent to the second band, defined by a composition wherein the elutable substance is a cream flavor, wherein the first band is oriented on the body below the second band, which is oriented below the third band.

32. A device according to claim 11, wherein the body has a shape selected from the group consisting of a triangular prism, a rectangular prism, a pentagonal prism, a hexagonal prism, an heptagonal prism, an octagonal prism, a nonagonal prism, a decagonal prism and wherein a composition comprising at least one different elutable substance or actives is disposed on different sides of the prism.

33. A device according to claim 32, wherein the body is a triangular prism and a first composition comprising sucralose is disposed on a first side of the prism, a second composition comprising a hazelnut flavor is disposed on a second side of the prism, and a third composition comprising a cream flavor is disposed on a third side of the prism.

34. A device according to claim 6, wherein the composition is visually detectable.

35. A device according to claim 34, wherein (a) the composition further comprises a coloring agent that is visually detectable on the body or (b) the body is colored and the presence of the composition, with or without a coloring agent, is visually detectable.

36. A device for delivering a elutable substance comprising a semi-permeable or impermeable body that is a rectangular prism with a length of about 6 inches, a width of about one-quarter of an inch and a depth of about one-thirty-second of an inch, wherein a composition comprising maltodextin and sucralose is affixed to a surface of the prism, wherein the amount of sucralose in the composition is sufficient to deliver about 3 sucrose equivalent teaspoons of sweetness to a foodstuff.

37. A method of producing a device for delivering an elutable substance comprising:
(a) providing a device comprising a body having a first end and a second end;
(b) coating at least a portion of the body with (1) a composition comprising a carrier or (2) a composition comprising an elutable substance dispersed in a carrier; and
(c) allowing the composition to dry to a surface of the body of the device, wherein upon contacting a coated surface of the body with a foodstuff, the elutable substance is dispersed into the foodstuff.

38. A method according to claim 37 further comprising, prior to step (c), contacting the composition (b)(1) or (b)(2), which is affixed to a surface of the body, with a elutable substance to form a dispersible layer of the elutable substance uniformly over the coated surface of the body.

39. A method according to claim 37, wherein the coating step comprises dipping, pouring, spraying, or brushing the composition onto a surface of the body.

40. A method according to claim 38, wherein the contacting step comprises dipping, dragging, dusting, pouring, brushing or spraying an elutable substance onto the portion of the body covered with the composition (b)(1) or (b)(2).

41. A method according to claim 37 further comprising repeating steps (a), (b), and optionally (c) to obtain a device having a plurality of different elutable substances dispersed on a surface of the body.

42. A method according to claim 37, wherein the elutable substance is selected from the group consisting of a high intensity sweetener, a nutritive sweetener, a sugar alcohol, a flavor, a drug substance, a vitamin, a mineral, a texture enhancer, a coloring agent, an aroma, and combinations thereof.

43. A method according to claim 42, wherein the elutable substance is a high intensity sweetener.

44. A method according to claim 43, wherein the high intensity sweetener is selected from the group consisting of aspartame, acesulfame, alitame, brazzein, cyclamic acid, dihydrochalcones, extract of Dioscorophyllum cumminsii, extract of the fruit of Pentadiplandra brazzeana, glycyrrhizin, hemandulcin, monellin, mogroside, neotame, neohesperidin, saccharin, sucralose, stevia, thaumatin, salts, derivatives, and combinations thereof.

45. A method according to claim 44, wherein the high intensity sweetener is sucralose.

46. A method according to claim 37, wherein the body has a length (z) equal to the distance between the first and second ends, a width (x), and a depth (y), wherein (z) is greater than (x) and (y).

47. A method according to claim 46, wherein the elutable substance in the composition is sucralose and the sucralose is present in the composition in an amount sufficient to provide to a foodstuff from about ½ to about 6 sucrose equivalent teaspoons of sweetness per unit length of the body.

48. A method according to claim 47, wherein the amount of sucralose in the composition is sufficient to provide to a foodstuff from about 1 to about 4 sucrose equivalent teaspoons of sweetness per unit length of the body.

49. A method according to claim 48, wherein the amount of sucralose in the composition is sufficient to provide to a foodstuff about 1 sucrose equivalent teaspoon of sweetness per unit length of the body.

50. A method according to claim 49, wherein the body has a shape selected from the group consisting of a triangular prism, a rectangular prism, a pentagonal prism, a hexagonal prism, an heptagonal prism, an octagonal prism, a nonagonal prism, and a decagonal prism.

51. A method according to claim 50, further comprising carrying out steps (b) and (c) on two or more sides of the body with compositions containing different elutable substances.

52. A method according to claim 46, wherein the coating step further comprises forming distinct adjacent bands of the composition along a surface of the body, wherein each band comprises a composition containing a different elutable substance.

53. A method according to claim 52, wherein the bands are oriented adjacent to each other beginning from the first end and proceeding upward toward the second end and the composition of each band comprises a higher amount of the elutable substance compared to the band immediately below it.

54. A method according to claim 53, wherein the elutable substance is sucralose.

55. A method according to claim 54, wherein the composition of the band closest to the first end comprises an amount of sucralose that provides to a foodstuff one sucrose equivalent teaspoon of sweetness and the composition of each band above it comprises an amount of sucralose that provides twice the sweetness of the band immediately below it.

56. A method according to claim 54, wherein the composition of the band closest to the first end comprises an amount of sucralose that provides to a foodstuff one-half a sucrose equivalent teaspoon of sweetness and the composition of each band above it comprises an amount of sucralose that provides twice the sweetness of the band immediately below it.
